(19) United States
(12) Patent Application Publication
(10) Pub. No.: US 2008/0236302 A1
(43) Pub. Date: Oct. 2, 2008

(54) COMPOUND STORAGE VESSEL HANDLING APPARATUS

(75) Inventor: James Norman Craven, Abbotsley (GB)

Correspondence Address: AMSTER, ROTHSTEIN & EBENSTEIN LLP, 90 PARK AVENUE, NEW YORK, NY, 10016, US

(73) Assignee: RTS LIFE SCIENCE LIMITED, Irlam (GB)

(21) Appl. No.: 12/135,834

(22) Filed: Jun. 9, 2008

Related U.S. Application Data
(62) Division of application No. 10/945,605, filed on Sep. 20, 2004.

(30) Foreign Application Priority Data
Sep. 25, 2003 (GB) 0322443.3

(51) Int. Cl. G01N 1/00

(52) U.S. Cl. 73/863.01

(57) ABSTRACT

Apparatus for handling compound storage vessels such as microtubes having a least one cavity for receiving a compound storage vessel. Each cavity is associated with a respective detector operative to detect the presence of a storage vessel in the cavity. The detector may comprise a spring form extending in the cavity and arranged to be deformed by a storage vessel when introduced into the cavity, and further arranged so that on deformation it closes an electrical switch indicating the presence of the microtube in the cavity. The presence of the spring form also increases friction between the storage vessel and the cavity retaining the storage vessel within the cavity.

### RELATED APPLICATION

This application is a divisional of U.S. patent application Ser. No. 10/945,605, entitled COMPOUND STORAGE VESSEL HANDLING APPARATUS, filed Sep. 20, 2004, the contents of which are incorporated herein by reference.

### FIELD OF THE INVENTION

The present invention relates to compound storage vessel handling apparatus. Particularly, although not exclusively, the invention relates to a lifting head for handling microtubes.

### BACKGROUND OF THE INVENTION

Contemporary drug development involves the preparation and storage of a large number of compounds, and subsequent later retrieval of selected compounds. Typically small quantities of compounds are stored in microtubes. The microtubes are stored in racks which are in turn stored in cold stores. Introduction of microtubes into a cold store and subsequent retrieval of selected microtubes is usually automated.

In our co-pending application number 0314686.7 a method and apparatus for handling microtubes are disclosed. The method is for handling a compound storage vessel disposed in a cavity in a rack, the cavity having an upper opening and a lower opening, and comprises the step of introducing a lifting pin into the cavity through the lower opening to urge the compound storage vessel upwards within the cavity. Correspondingly the apparatus is for handling a compound storage vessel disposed in a cavity in a rack, the cavity having an upper opening and a lower opening, and comprises a lifting pin and associated actuator, the lifting pin being arranged to be inserted into the cavity through the lower opening and operable by means of the actuator to urge the compound storage vessel upwards within the cavity.

Using a lifting pin enables individual compound storage vessels to be selected and raised within a rack.

In one embodiment the method is for removing a selected vessel or vessels from wrack and further comprises the step of locating a lifting head defining at least one cavity over the rack so that the at least one cavity is aligned with the cavity in the rack containing the selected vessel, raising the selected vessel out of its cavity in the rack by means of the lifting pin so that the vessel is introduced into the cavity in the lifting head such that the vessel becomes retained relative to the lifting head.

The lifting head and rack may then be moved apart and the lifting head placed over another rack such that the cavity or cavities in the lifting head containing selected vessels are aligned with cavities in the other rack. The or each vessel retained in the lifting head may then be displaced from the lifting head into the one or more cavities in the rack. The or each vessel is preferably arranged to be retained within a cavity of the receiving head by means of a friction fit.

It is an object of this invention to provide improved apparatus for handling compound storage vessels and particularly, although not exclusively, a lifting head for handling microtubes.

According to the present invention there is provided apparatus for handling compound storage vessels comprising at least one cavity for receiving a compound storage vessel, the or each cavity being associated with a respective detector operative to detect the presence of a compound storage vessel in the cavity.

Provision of a detector or detectors enables automated vessel handling apparatus to determine if a cavity is populated. This is particularly useful where the apparatus comprises a large number of cavities.

In one embodiment a detector comprises a first electrical contact arranged on introduction of a compound storage vessel into the cavity to be urged into contact with a second electrical contact, thereby to complete an electrical circuit to indicate the presence of a vessel in the cavity.

The or each cavity may include a resiliently biassed member extending into the cavity and operative to urge a vessel introduced into the cavity against a wall of the cavity thereby to help retain the vessel relative to the cavity. The resiliently biassed member may comprise a spring form which may be disposed in a slot formed in a wall of the cavity. Movement of the resiliently biassed member may be arranged to cause the first and second electrical contacts to come into contact. In one embodiment the resiliently biassed member comprises a spring form incorporating an electrical contact arranged, in use, to come into contact with a second contact disposed on a printed circuit board when a compound storage vessel is introduced into the cavity.

Preferably the apparatus forms a lifting head for lifting microtubes from a microtube storage rack.

### BRIEF DESCRIPTION OF THE DRAWINGS

In order that the invention may be more clearly understood an embodiment thereof will now be described by way of example with reference to the accompanying drawings of which:

FIG. 1 is a side schematic cross-sectional view of a lifting head being used to remove microtubes from a microtube storage rack;

FIG. 2 is a cutaway perspective view of a microtube cavity of apparatus according to the invention;

FIG. 3 shows a side cross-sectional view of the cavity of FIG. 2 comprised in a lifting head;

FIG. 4 is a plan view of the cavity of FIG. 2; and

FIG. 5 shows how cavities of the shape illustrated in FIGS. 2 to 4 may be arranged together to form a lifting head having a plurality of such cavities.

### DETAILED DESCRIPTION OF PREFERRED EMBODIMENTS

In the following description references to upper, lower, top bottom and the like refer to the apparatus as illustrated, and are not intended to be limiting in any other way.

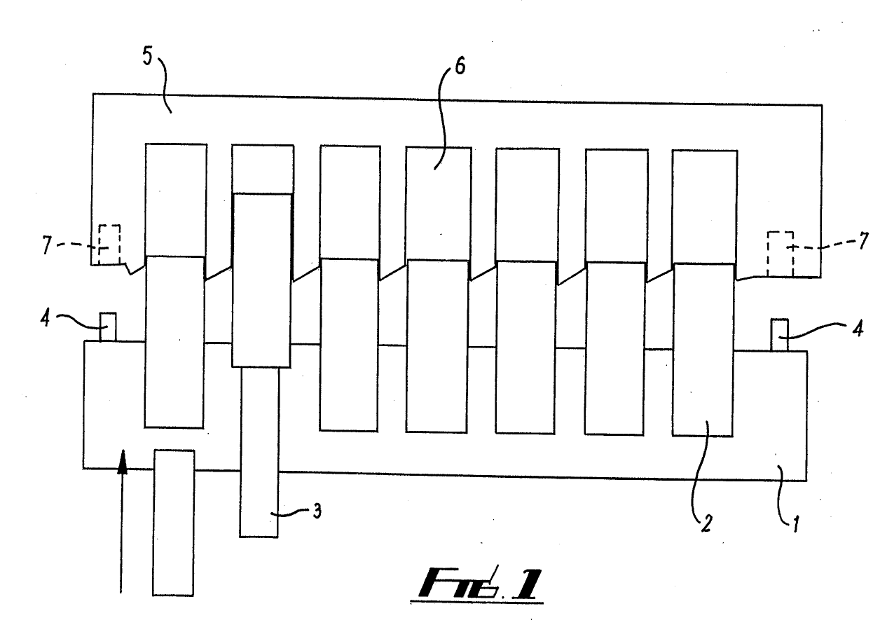

FIG. 1 shows in general how a lifting head (whether or not it includes the present invention) is used in the selection of microtubes from a microtube rack. Referring to FIG. 1, a microtube rack 1 defines a plurality of open topped cavities in each of which is disposed a microtube 2. The bottom of each cavity is partially closed to provide support for the microtubes 2 whilst permitting a lifting pin 3 to be introduced into the cavity beneath the microtube 2. Alignment pins 4 extend from the upper surface of the microtube 2 rack.

A lifting head 5 is used to remove selected microtubes 2 from the microtube rack 1. The lifting head 5 defines a plurality of cavities 6 for receiving microtubes 2. The cavities are sized so that the microtubes 2 fit into the cavities 6 with an interference fit. The cavities 6 are open to the bottom and at least partially open to the top to enable a pin to be introduced from above to displace any microtube 2 disposed in a cavity of a lifting head 5 out of the cavity through its lower opening. The underside of the lifting head includes alignment apertures 7.

When it is desired to remove selected microtubes from the microtube rack the lifting head 5 is placed over the rack so that the cavities of the lifting head and the cavities of the rack are aligned and alignment pins 4 are received into alignment holes 7. Selected microtubes 2 are then raised out of their cavities in the rack and urged into the corresponding cavity of the lifting head 5 by means of a lifting pin 3 introduced into the cavity in the rack from below. The lifting head 5 can then be removed from the rack 1 with the selected microtubes 2 retained within cavities of the lifting head. Subsequently the lifting head may be placed over another rack and the microtubes 2 retained in the lifting head displaced from the lifting head into the new rack by means of pins introduced into the cavities of the lifting head 1 from above.

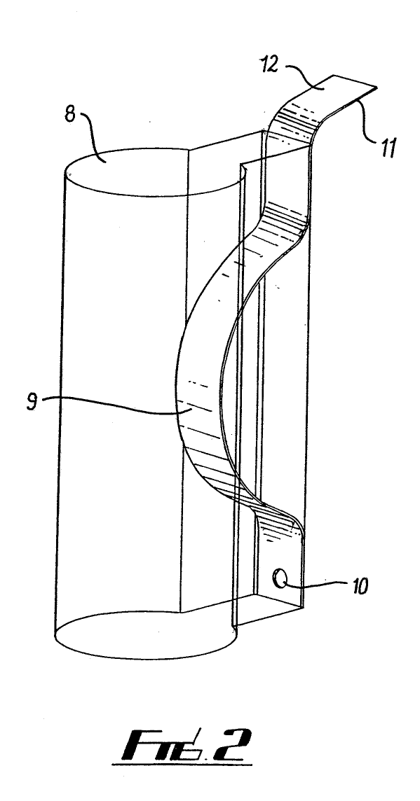

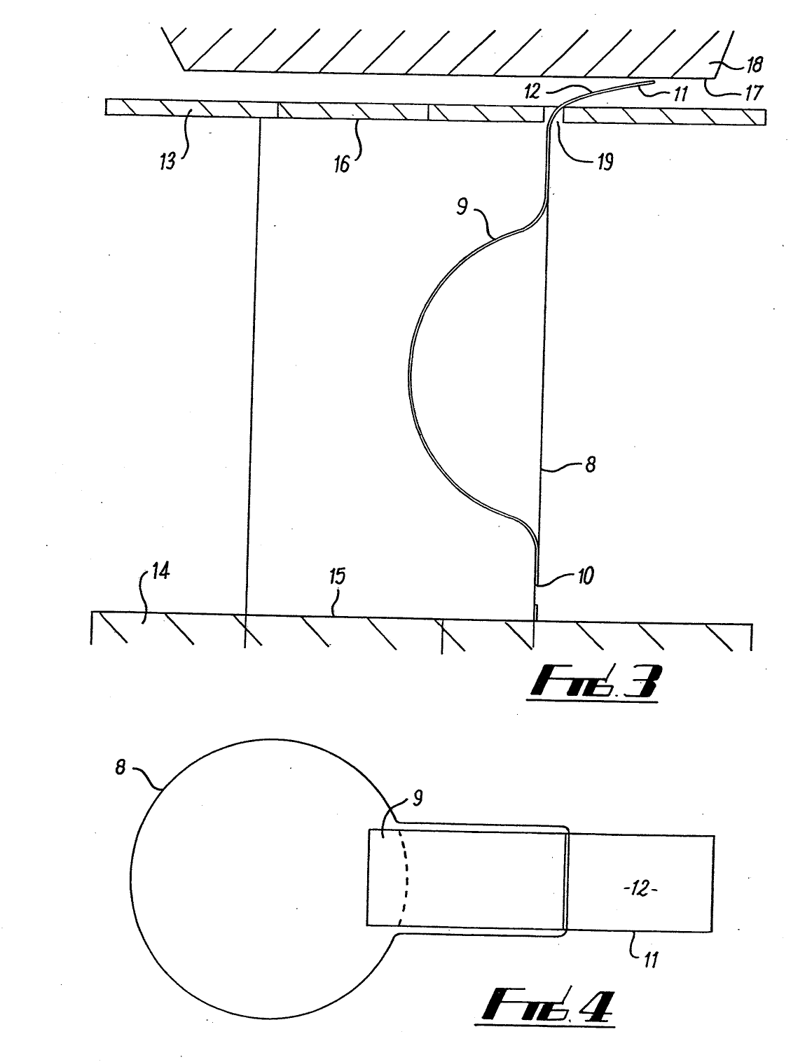

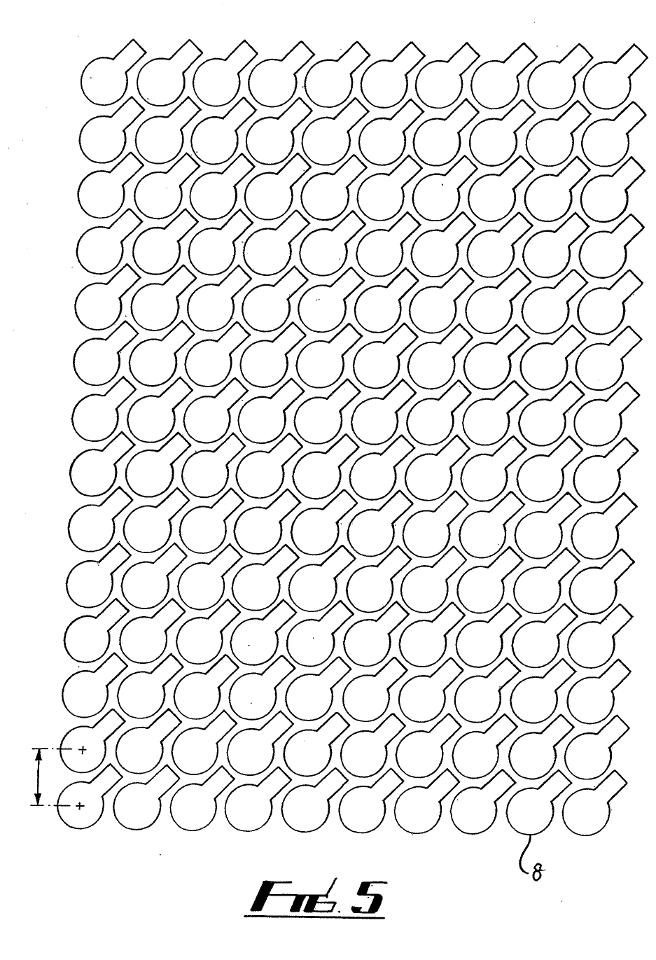

Features of a lifting head of an embodiment of the present invention having a plurality of cavities are shown in FIGS. 2 to 5. For simplicity only a single cavity is shown in FIGS. 2 to 4. Referring to FIGS. 2 to 5 each cavity 8 is of a generally keyhole shaped cross-section. Each cavity 8 comprises a portion of substantially circular cross-section and a portion of substantially rectangular section, formed by a longitudinal slot extending in a wall of a substantially circular cavity. The portion of the cavity 8 of substantially circular cross-section is intended to accommodate a microtube, which should ideally have a close sliding fit within this portion of the cavity.

A spring form 9 is disposed within the slot of the cavity 8. The spring form 9 is formed from a suitable electrically conductive material, for example Beryllium Copper. One end of the spring form 9 is flattened and fixed within the slot of the cavity so that it cannot move relative to the slot. This end of the spring form 9 is fixed by way of a detent 10, although any other suitable means of fixing may be employed. The spring form 9 extends from the flat portion in an arcuate fashion. The arcuate portion of the spring form 9 extends out of the slot into the portion of the cavity 8 of substantially circular cross-section and back into the slot where a second flattened portion of spring form is found leading to a tail, having an electrical contact surface, the tail extending out of the slot.

In a microtube lifting head each cavity extends between top 13 and bottom 14 plates. The bottom plate 14 includes a plurality of substantially circular apertures 15 each one disposed concentrically with and substantially the same size as the circular portion of a respective cavity 8 so that microtubes may enter and leave each cavity through the bottom plate 14. The top plate 13 also includes a plurality of substantially circular apertures 16 concentric with the substantially circular portion of each cavity. In contrast to the top plate though each aperture 16 has a diameter sufficiently smaller than that of the substantially circular portion of each cavity so that microtubes will not pass through the top plate 13 but a pin of smaller diameter than the microtubes can do so in order to displace microtubes from the cavity 8. Further apertures 19 (which may connect with the substantially circular apertures 16) are formed in the top plate 13 through which the spring form 9 of each cavity extends. The tail portion 11 of each spring form extends at right angles to the longitudinal axis of the cavity 8. Adjacent but spaced apart from the tail portion 11 of each spring form is an electrical contact 17 comprised in a printed circuit board 18.

In use a microtube is introduced into the cavity 8 through aperture 15 in the bottom plate 14. As the microtube substantially fills the portion of the cavity of circular cross-section as it moves into the cavity 8 it comes into contact with the arcuate portion of the spring form 9. This causes the spring form 9 to deform. As the spring form 9 deforms the arcuate portion becomes flattened the effect of which is to urge opposite ends of the spring form 9 apart. The lower flattened end of the spring form cannot move relative to the slot in which it is disposed, both because of detent 10 and because the end of the spring form 9 is in contact with the bottom plate 14. The upper flattened end of the spring form is, however, able to move since it can pass through aperture 19 in the upper plate 13. This causes the tail 11 of the spring form to move towards electrical contact 17 and electrical contact 12 to make contact with contact 17. This completes an electrical circuit enabling automatic microtube handling apparatus to determine that a microtube is present in the cavity 8.

The spring form 9 serves a dual function. When a microtube is inserted into the cavity 8 the spring form 9 urges the microtube towards the opposite wall of the cavity ensuring a good friction fit between the microtube and cavity and therefore that the microtube is retained within the cavity. Secondly the spring form acts, in conjunction with electrical contact 17, as an electrical switch which is closed when a microtube is introduced into the cavity and reopens when a microtube is displaced out of the cavity owing to the fact that the spring form will return to its original shape on removal of the microtube.

The keyhole shape of the cavities enables a plurality of cavities to be arranged closely together, in a manner illustrated in FIG. 5. In one practical embodiment the centre points of the circular portion of each cavity are spaced apart by 4.5 mm. Whilst an array of 140 cavities has been illustrated apparatus can be provided with any convenient number of cavities.

The above embodiment is described by way of example only. Many variations are possible without departing from the invention as defined by the following claims.

What is claimed is:

1. A method for handling a compound storage vessel comprising the steps of:
(a) providing an apparatus comprising at least one cavity for receiving at least one compound storage vessel;
(b) locating the apparatus over a rack containing at least one compound storage vessel; and
(c) displacing the at least one compound storage vessel from the rack into the at least one cavity of the apparatus.

2. The method of claim 1, comprising the additional step of displacing the at least one compound storage vessel from the at least one cavity of the apparatus to a second rack.

3. The method of claim 1, further comprising the step of urging the at least one compound storage vessel against a wall of the at least one cavity using a resiliently biased member disposed in a slot in the wall of the at least one cavity and extending into the at least one cavity, thereby to retain the at least one compound storage vessel relative to the at least one cavity.

4. The method of claim 1, further comprising the step of detecting the presence of a compound storage vessel in the at least one cavity using an associated detector that is operatively connected to the at least one cavity of the apparatus.

5. The method of claim 4, further comprising the step of urging within the detector a first electrical contact into contact with a second electrical contact upon the introduction of the at least one compound storage vessel into the at least one cavity, thereby completing an electrical circuit indicating the presence of the at least one compound storage vessel in the at least one cavity.

6. The method of claim 5, wherein movement of the resiliently biased member, caused by introduction of the at least one compound storage vessel into the cavity, results in the first electrical contact and the second electrical contact coming into contact with one another.

8. The method of claim 5, wherein the resiliently biased member comprises a spring form and the spring form is the first electrical contact and a printed circuit board is the second electrical contact.

9. The method of claim 1, wherein the at least one compound storage vessel is a microtube.
